(19) United States
(12) Patent Application Publication
(10) Pub. No.: US 2024/0176759 A1
(43) Pub. Date: May 30, 2024

(54) MACHINE LEARNING PARALLELIZATION METHOD USING HOST CPU WITH MULTI-SOCKET STRUCTURE AND APPARATUS THEREFOR

(71) Applicant: ELECTRONICS AND TELECOMMUNICATIONS RESEARCH INSTITUTE, Daejeon (KR)

(72) Inventors: Baik-Song AN, Seoul (KR); Ki-Dong KANG, Daejeon (KR); Hong-Yeon KIM, Daejeon (KR); Myung-Hoon CHA, Daejeon (KR)

(73) Assignee: ELECTRONICS AND TELECOMMUNICATIONS RESEARCH INSTITUTE, Daejeon (KR)

(21) Appl. No.: 18/521,396

(22) Filed: Nov. 28, 2023

(30) Foreign Application Priority Data
Nov. 30, 2022 (KR) 10-2022-0164411

(51) Int. Cl. G06F 15/80; G06F 9/52; G06F 9/54

(52) U.S. Cl. CPC G06F 15/80; G06F 9/52; G06F 9/544

(57) ABSTRACT

Disclosed herein are a method for machine-learning parallelization using host CPUs of a multi-socket structure and an apparatus therefor. The method, performed by the apparatus for machine-learning parallelization using host CPUs of a multi-socket structure, includes a compile phase in which a learning model is split at a layer level for respective pipeline stages and allocated to Non-Uniform Memory Access (NUMA) nodes for respective CPU sockets and a runtime phase in which parameters required for learning are initialized and multiple threads generated in consideration of a policy of each parallelism algorithm are executed by being allocated to respective cores included in the NUMA node.

### CROSS REFERENCE TO RELATED APPLICATION

This application claims the benefit of Korean Patent Application No. 10-2022-0164411, filed Nov. 30, 2022, which is hereby incorporated by reference in its entirety into this application.

### BACKGROUND OF THE INVENTION

### 1. Technical Field

The present disclosure relates generally to technology for machine-learning parallelization using host CPUs of a multi-socket structure, and more particularly to technology that enables parallel training and inference while minimizing performance load when large-scale machine-learning based on host CPUs is performed in a general multi-socket-based server without special computing devices, such as GPUs.

### 2. Description of the Related Art

With the recent explosive spread of Artificial Intelligence (AI) and deep-learning technology, the demand for higher accuracy and performance of AI is rapidly increasing. As a result, AI model sizes also grow exponentially, and such a trend surpasses the pace of development of related hardware. In the case of GPU devices, which are most widely used for AI training and inference, the amounts of computation and memory required for a currently widely used large-scale model are enormously increased to be higher than a single GPU can support. In other words, in order to enable training and service using a large-scale AI model, there is no choice but to use a method of performing parallel training and inference by distributing the model to a system in which multiple GPUs are installed. Here, when the single model is executed by being distributed across the multiple GPUs, it is necessary to store the model in multiple GPU memory units that are not shared. This requires collective communication, which results in huge communication load, and this is one of the biggest causes of performance degradation in parallel training.

Although GPUs are computing devices most commonly used for AI training and inference, recently released host CPUs include a plurality of additional functions for deep-learning acceleration. Accordingly, techniques capable of performing machine learning using only a host CPU without GPUs or special computing devices by accelerating various kinds of operations required for deep-learning using Advanced Vector Extensions 512 (AVX-512) or the like, which is a representative Single Instruction Multiple Data (SIMD) instruction set of X86 architecture, are continuously released. Such host-CPU-based machine-learning is expected to be used more widely in the future.

The greatest advantage of host-CPU-based machine-learning is that it is possible to directly use large shared system memory. Because GPU memory has a small size and is not shared, it is difficult to process a large-scale model in a distributed manner. In contrast, when large system memory is used, a model may be loaded into the memory without splitting and may be shared by all CPU cores, and the cores may communicate with each other through the memory. Furthermore, because a local bus for connecting CPU sockets in nodes and a Network-on-Chip (NoC) for connecting cores in the socket have good performance, communication load may be minimized.

However, most multi-socket-based servers in which multiple CPUs are installed are designed based on Non-Uniform Memory Access (NUMA) architecture. This is architecture in which memory connected to each CPU socket is shared, and when memory of other CPU sockets is accessed, performance becomes lower than when memory local to the corresponding socket is accessed. Therefore, when distributed training based on CPUs is performed, it is necessary to recognize such NUMA architecture, and a technique for enabling parallel training optimized for the NUMA architecture is required.

That is, in order to execute an AI model by distributing operations, variables, and the like of the AI model across multiple NUMA nodes, it is necessary to split the model in consideration of the NUMA architecture. Furthermore, because most of various types of parallelism techniques recently proposed for large-scale machine-learning (e.g., pipeline parallelism, tensor parallelism, data parallelism, etc.) assume a multi-GPU environment, a new method for applying these techniques to a host-CPU-based deep-learning environment is required.

### Documents of Related Art

(Patent Document 1) U.S. Application Publication No. US2021/0149729, published on May 20, 2021 and titled “Task scheduling for machine-learning workloads”.

### SUMMARY OF THE INVENTION

An object of the present disclosure is to enable efficient large-scale machine-learning while minimizing performance load when parallel machine-learning based on host CPUs is performed using physical characteristics of each layer of a multi-socket system.

Another object of the present disclosure is to effectively parallelize a distributed machine-learning model using host CPUs and system memory by utilizing physical characteristics of a NUMA node system without special computing devices, such as GPUs.

A further object of the present disclosure is to apply a parallelization technique for minimizing load using a performance difference between interconnects of multiple layers of a system, thereby improving performance in parallel training and inference of a large-scale model.

In order to accomplish the above objects, a method for machine-learning parallelization using host CPUs of a multi-socket structure according to the present disclosure, performed by an apparatus for machine-learning parallelization using host CPUs of a multi-socket structure, includes a compile phase in which a learning model is split at a layer level for respective pipeline stages and allocated to Non-Uniform Memory Access (NUMA) nodes for respective CPU sockets and a runtime phase in which parameters required for learning are initialized and multiple threads generated in consideration of a policy of each parallelism algorithm are executed by being allocated to multiple cores included in the NUMA node.

Here, the NUMA node for each of the CPU sockets may include a CPU, including multiple cores, and memory, the multiple cores may share the memory via an interconnect between the cores, and the NUMA node for each of the CPU sockets may share memory of each NUMA node via an interconnect between the sockets.

Here, a default value for the number of pipeline stages may be set to correspond to the number of NUMA nodes, and an equal number of model operations may be distributed to each of the NUMA nodes.

Here, the parameters may include global parameters for sharing data between the multiple threads and local parameters used individually by each of the multiple threads.

Here, the local parameters may store a gradient for loss and a state of an optimizer for determining whether to apply the gradient, which are used in a backpropagation process of the learning model.

Here, the runtime phase may include synchronizing execution of the threads allocated to each of the NUMA nodes and updating the parameters for each of the NUMA nodes based on the global parameters.

Here, updating the parameters may comprise updating the parameters using any one of a method in which the multiple threads synchronously update the parameters and a method in which the multiple threads asynchronously update the parameters.

Also, an apparatus for machine-learning parallelization using host CPUs of a multi-socket structure according to an embodiment of the present disclosure includes a processor for splitting a learning model at a layer level for respective pipeline stages, allocating parts of the split learning model to Non-Uniform Memory Access (NUMA) nodes for respective CPU sockets, initializing parameters required for learning, and executing multiple threads generated in consideration of a policy of each parallelism algorithm by allocating the multiple threads to multiple cores included in the NUMA node; and memory for storing the parallelism algorithm.

Here, the NUMA node for each of the CPU sockets may include a CPU, including multiple cores, and memory, the multiple cores may share the memory via an interconnect between the cores, and the NUMA node for each of the CPU sockets may share memory of each NUMA node via an interconnect between the sockets.

Here, a default value for the number of pipeline stages may be set to correspond to the number of NUMA nodes, and an equal number of model operations may be distributed to each of the NUMA nodes.

Here, the parameters may include global parameters for sharing data between the multiple threads and local parameters used individually by each of the multiple threads.

Here, the local parameters may store a gradient for loss and a state of an optimizer for determining whether to apply the gradient, which are used in a backpropagation process of the learning model.

Here, the processor may synchronize execution of the threads allocated to each of the NUMA nodes and update the parameters for each of the NUMA nodes based on the global parameters.

Here, the processor may perform parameter update using any one of a method in which the multiple threads synchronously update the parameters and a method in which the multiple threads asynchronously update the parameters.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a flowchart illustrating a method for machine-learning parallelization using host CPUs of a multi-socket structure according to an embodiment of the present disclosure;

FIG. 2 is a view illustrating an example of host CPUs of a multi-socket structure according to the present disclosure;

FIG. 3 is a flowchart illustrating in detail a compile phase in a method for machine-learning parallelization according to an embodiment of the present disclosure;

FIG. 4 is a flowchart illustrating in detail a runtime phase in a method for machine-learning parallelization according to an embodiment of the present disclosure;

FIGS. 5 to 7 are views illustrating an example of parallel execution of a multi-thread-based model using host CPUs of a multi-socket structure according to the present disclosure;

FIG. 8 is a block diagram illustrating an apparatus for machine-learning parallelization using host CPUs of a multi-socket structure according to an embodiment of the present disclosure;

FIG. 9 is a block diagram illustrating an apparatus for machine-learning parallelization using host CPUs of a multi-socket structure according to another embodiment of the present disclosure;

FIG. 10 is a block diagram illustrating the runtime module illustrated in FIG. 9 in detail; and

FIG. 11 is a view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

Hereinafter, a preferred embodiment of the present disclosure will be described in detail with reference to the accompanying drawings.

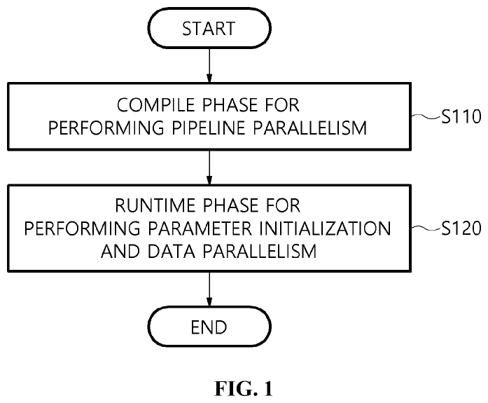

FIG. 1 is a flowchart illustrating a method for machine-learning parallelization using host CPUs of a multi-socket structure according to an embodiment of the present disclosure.

Referring to FIG. 1, in the method for machine-learning parallelization using host CPUs of a multi-socket structure according to an embodiment of the present disclosure, an apparatus for machine-learning parallelization using host CPUs of a multi-socket structure performs a compile phase in which a learning model is split at a layer level for respective pipeline stages and allocated to Non-Uniform Memory Access (NUMA) nodes for respective sockets at step S110.

Here, the NUMA node for each of the CPU sockets may include a CPU, including multiple cores, and memory, the multiple cores may share the memory via an interconnect therebetween, and the NUMA node for each of the CPU sockets may share memory of each NUMA node via an interconnect between the sockets.

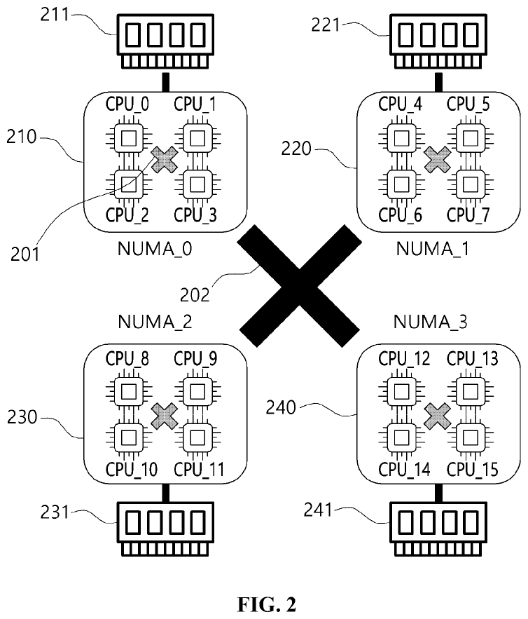

For example, FIG. 2 illustrates host CPUs of a multi-socket structure to perform parallel machine-learning according to an embodiment of the present disclosure. In the example of FIG. 2, four CPU sockets are present, and CPUs 210, 220, 230, and 240, each having four cores, may be installed in the respective sockets. The four-core CPUs 210, 220, 230, and 240 are connected to memory units 211, 221, 231, and 241, respectively, thereby forming their own NUMA nodes.

Here, the cores included in the same CPU may share the memory of the NUMA node corresponding thereto, in which case the cores may access the memory with the same performance.

Also, the cores in each of the CPUs 210, 220, 230, and 240 may be connected with each other via an interconnect 201 between the cores, and the NUMA nodes may be connected with each other via an interconnect 202 between the sockets. Here, the interconnect 202 between the sockets shows lower performance than the interconnect 201 between the cores.

Therefore, access to memory of another NUMA node shows lower performance than access to memory local to the corresponding NUMA node.

Here, a default value for the number of pipeline stages is set to correspond to the number of NUMA nodes, and an equal number of model operations may be distributed to each of the NUMA nodes.

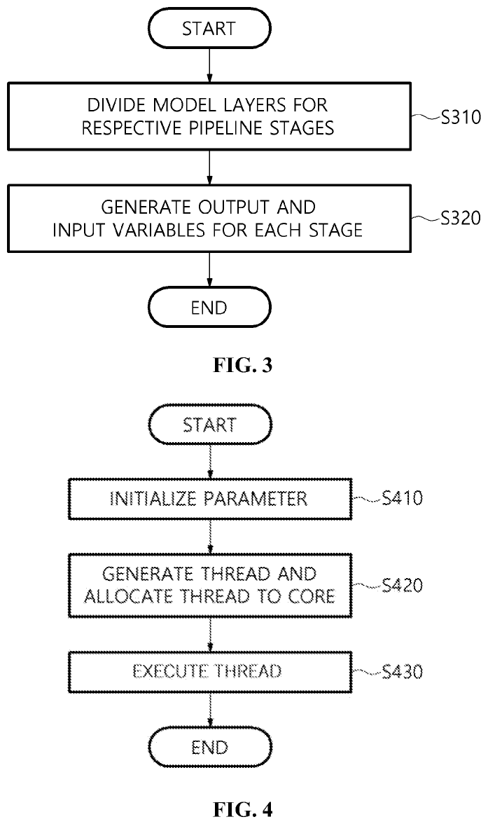

For example, FIG. 3 illustrates a process of performing pipeline parallelism at the compile phase in detail. First, model operations may be distributed to respective pipeline stages in consideration of the number of pipeline stages and the number of operations of the corresponding model, that is, the number of layers of the model, at step S310.

Here, the performance of the interconnect between the sockets (the interconnect between the NUMA nodes) is lower than the performance of the interconnect between the cores in each of the sockets, and pipeline parallelism is less sensitive to the performance of the interconnect than tensor parallelism or data parallelism. Therefore, the default value for the number of pipeline stages may be set to the number of NUMA nodes in the system.

If the number of layers of the model is I and the number of pipeline stages is n, the number of layers to be distributed to the i-th stage of the pipeline, kᵢ, may be calculated as shown in Equation (1):

$${k}_{0} = ⌈ \frac{l}{n} ⌉ , {k}_{i} = ⌈ \frac{l - {Σ}_{j = 0}^{i - 1} {k}_{j}}{n - i} ⌉ \qquad ( 1 )$$

This method may be a method of distributing an equal number of layers to each of the pipeline stages on the assumption that the performance load is the same in the layers of the model. In the case of a model having a large performance difference between the layers thereof, a method of measuring the performance load of each layer through profiling and distributing the layers in consideration of the performance load may be applied.

Also, in the method for machine-learning parallelization using host CPUs of a multi-socket structure according to an embodiment of the present disclosure, the apparatus for machine-learning parallelization using host CPUs of a multi-socket structure performs a runtime phase in which parameters required for learning are initialized and multiple threads generated in consideration of policies of each parallelism algorithm are executed by being allocated to the multiple cores included in the NUMA node at step S120.

Here, the parameters may include global parameters for sharing data between the multiple threads and local parameters used individually by each of the multiple threads.

For example, after the model layers are distributed to the respective pipeline stages through the compile phase, global parameters for sharing output values and input values between adjacent pipeline stages may be generated. The global parameters generated or defined as described above may be used when threads for different pipeline stages share data therebetween.

Here, the local parameters may store a gradient for loss and the state of an optimizer for determining whether to apply the gradient, which are used in the backpropagation process of the learning model.

For example, Table 1 illustrates an example of code for implementing a machine-learning model written by a user.

TABLE 1

```
parameter_1[ ]...[ ];
parameter_2[ ]...[ ];
...
parameter_16[ ]...[ ];
model(...) {
  optimizer_state_1[ ]...[ ];
  optimizer_state_2[ ]...[ ];
  ...
  optimizer_state_16[ ]...[ ];
  gradient_1[ ]...[ ];
  gradient_2[ ]...[ ];
  ...
  gradient_16[ ]...[ ];
  operation_1( );
  operation_2( );
  ...
  operation_8( );
  operation_8_back( );
  operation_7_back( );
  ...
  operation_1_back( );
}
```

In the example of Table 1 above, a description is made on the assumption that a machine-learning model is defined based on eight operations for convenience.

Here, when the model is used only for inference, it is necessary to define only forward operations, and when training of the model is performed, it is necessary to also define backpropagation operations. For example, in Table 1, the operations defined as ‘operation_X’ may correspond to the forward operations, and the operations defined as ‘operation_X_back’ may correspond to the backpropagation operations.

The machine-learning model defined as described above may be executed in parallel as multiple threads.

Here, because the multiple threads share the parameters when parallel execution is performed, the parameters may be defined as global parameters for sharing data between the threads. For example, the parameters defined as ‘parameter_X[ ] . . . [ ]’ in Table 1 may correspond to the global parameters.

Also, gradients for loss, an optimizer for determining how to apply the gradients when the parameters are updated, and the task for updating the parameters may be additionally required for the backpropagation process performed when the model is trained.

Accordingly, it is necessary to declare the parameters for storing the gradients (gradient_X[ ] . . . [ ]), the optimizer state (optimizer_state_X[ ] . . . [ ]), and the like, which are required for the model training process, and because the gradient and the optimizer state are used by each individual thread without being shared between the threads, they may be declared as local parameters.

These days, many deep-learning libraries provide an automatic differentiation function, and when this function is used, a backpropagation process may be automatically generated and performed merely by defining a forward process of a model. When such an automatic differentiation function is used, it is necessary to define and specify only forward operations of a model, and the gradients or optimizer state described above may not be defined because they are automatically generated.

Here, execution of the threads allocated to each of the NUMA nodes may be synchronized.

Here, the parameters may be updated for each of the NUMA nodes based on the global parameters.

Here, the parameters may be updated using any one of a method in which the multiple threads update the parameters synchronously or a method in which the multiple threads update the parameters asynchronously.

As described above, the present disclosure is largely divided into a compile phase and a runtime phase. At the compile phase, a model may be split by reflecting the characteristics of a target system, and the runtime phase may be performed by generating and managing multiple threads based on the result of the compile phase. Accordingly, the task for pipeline parallelism may be performed by a compile function, and tasks after that may be performed by a runtime function.

For example, after the task at the compile phase, which is the task of splitting a model at a layer level for respective pipeline stages, is performed through a pipeline parallelization task, the model code written by a user is converted into multiple threads so as to match parallelization configurations and is then compiled, thereby being generated as a final executable file. The generated executable file may be executed through the runtime function. Here, parameter values are initialized, multiple threads are generated according to a policy of each parallelism algorithm and allocated to CPU cores, and the threads allocated to the respective cores are executed, whereby training of the model may be started.

Here, as commonly used model parallelism methods, there are three methods, which are pipeline parallelism, data parallelism, and tensor parallelism. At the compile phase according to the present disclosure, only pipeline parallelism is handled due to the following reasons.

The most important task in data parallelism is to update parameters of threads through global parameters, but this can be performed at the runtime phase of the present disclosure, so a compile process therefor is not required.

The purpose of performing tensor parallelism is to split a single layer of a model when the layer cannot be loaded onto limited GPU memory, but in the case of host-CPU-based deep-learning assumed in the present disclosure, all threads for the same pipeline stage are executed in the same NUMA node, so they share the memory of the NUMA node. Therefore, tensor parallelism, in which each layer of a model is split, contributes nothing to performance improvement, and is not taken into consideration in the present disclosure.

Through the above-described method for machine-learning parallelization using host CPUs of a multi-socket structure, efficient large-scale machine-learning may be enabled while minimizing performance load when parallel machine-learning based on host CPUs is performed using physical characteristics of layers of the multi-socket structure.

Also, a distributed machine-learning model using host CPUs and system memory may be effectively parallelized by utilizing physical characteristics of a NUMA node system without special computing devices, such as GPUs.

Also, a parallelization technique for minimizing load using the performance difference between interconnects of multiple layers of a system is applied, whereby performance may be improved when parallel training and inference of a large-scale model are performed.

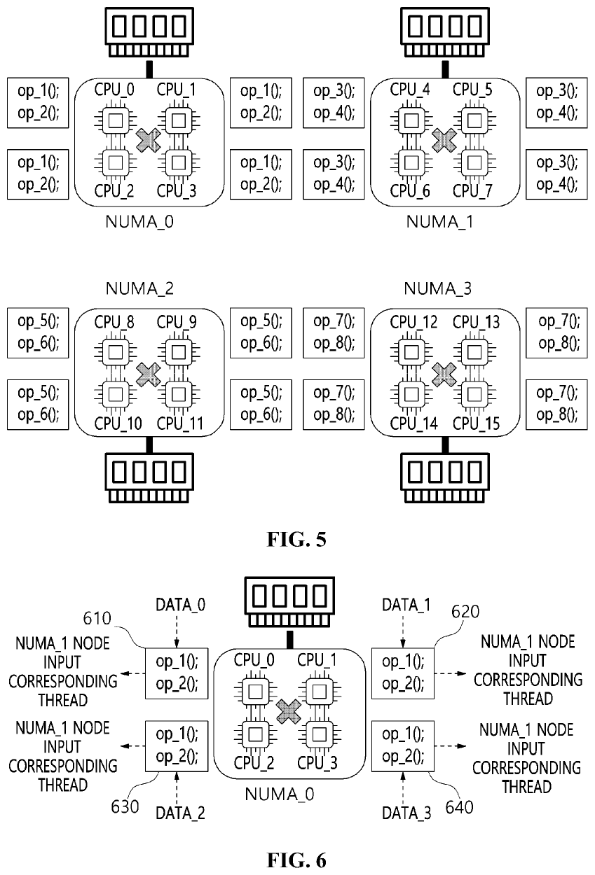

FIGS. 5 to 7 are views illustrating an example of parallel execution of a multi-thread-based model using host CPUs of a multi-socket structure according to the present disclosure.

First, FIG. 5 illustrates an example of parallel execution of a multi-thread-based model using host CPUs in a server in which four CPUs, each having four cores, are installed.

Here, when pipeline parallelism is performed on the assumption that a model includes eight layers (operations), a total of four pipeline stages are allocated by assigning each of the pipeline stages to each of the CPU sockets illustrated in FIG. 5, after which two layers may be assigned to each of the stages.

Subsequently, threads 610 to 640 allocated to the respective cores in the same CPU socket are applied to process pieces of input data DATA_0 to DATA_3, respectively, as illustrated in FIG. 6, whereby parallelism by which a total of four pieces of input data are processed in parallel may be performed.

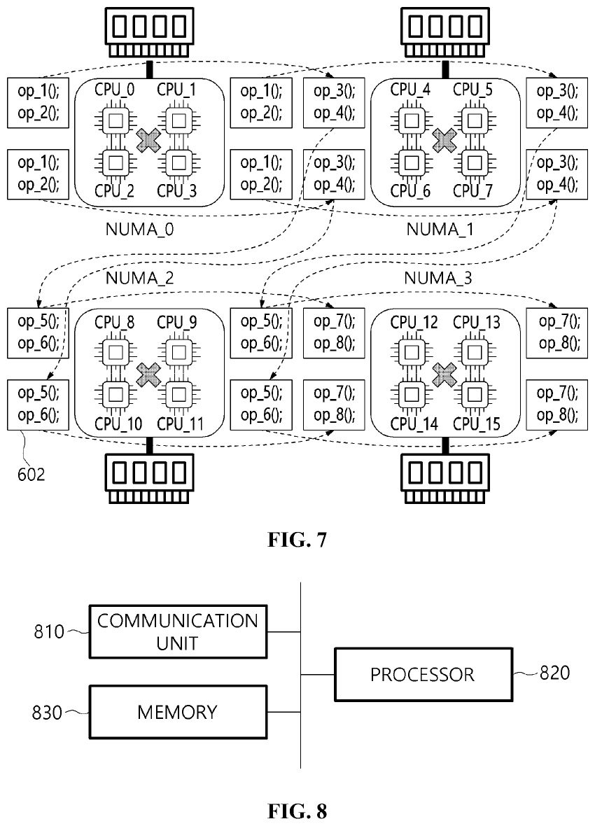

Here, the threads that process the same input data throughout the pipeline stages transfer the current output value thereof as the input value of the corresponding thread of the next socket, as illustrated in FIG. 7, thereby performing pipelined parallel processing. Accordingly, in the server in which four CPUs, each having four cores, are installed, training may be performed by generating a total of 16 threads, and synchronization between these threads may be performed in the runtime process, which will be described later with reference to FIG. 10.

FIG. 8 is a block diagram illustrating an apparatus for machine-learning parallelization using host CPUs of a multi-socket structure according to an embodiment of the present disclosure.

Referring to FIG. 8, the apparatus for machine-learning parallelization using host CPUs of a multi-socket structure according to an embodiment of the present disclosure includes a communication unit 810, a processor 820, and memory 830.

The communication unit 810 may serve to transmit and receive information for machine-learning parallelization through a communication network.

The processor 820 performs a compile phase in which a learning model is split at a layer level for respective pipeline stages and allocated to Non-Uniform Memory Access (NUMA) nodes of respective sockets.

Here, the NUMA node for each of the CPU sockets may include a CPU, including multiple cores, and memory, the multiple cores may share the memory via an interconnect therebetween, and the NUMA node for each of the CPU sockets may share memory for each NUMA node via an interconnect between the sockets.

For example, FIG. 2 illustrates host CPUs of a multi-socket structure to perform parallel machine-learning according to an embodiment of the present disclosure. In the example of FIG. 2, four CPU sockets are present, and CPUs 210, 220, 230, and 240, each having four cores, may be installed in the respective sockets. The four-core CPUs 210. 220, 230, and 240 are connected to memory units 211, 221, 231, and 241, respectively, thereby forming their own NUMA nodes.

Here, the cores included in the same CPU may share the memory of the NUMA node corresponding thereto, in which case the cores may access the memory with the same performance.

Also, the cores in each of the CPUs 210, 220, 230, and 240 may be connected with each other via an interconnect 201 between the cores, and the NUMA nodes may be connected with each other via an interconnect 202 between the sockets. Here, the interconnect 202 between the sockets shows lower performance than the interconnect 201 between the cores.

Therefore, access to memory of another NUMA node shows lower performance than access to memory local to the corresponding NUMA node.

Here, a default value for the number of pipeline stages is set to correspond to the number of NUMA nodes, and an equal number of model operations may be distributed to each of the NUMA nodes.

For example, FIG. 3 illustrates a process of performing pipeline parallelism at the compile phase in detail. First, model operations may be distributed to respective pipeline stages in consideration of the number of pipeline stages and the number of operations of the corresponding model, that is, the number of layers of the model, at step S310.

Here, the performance of the interconnect between the sockets (the interconnect between the NUMA nodes) is lower than the performance of the interconnect between the cores in each of the sockets, and pipeline parallelism is less sensitive to the performance of the interconnect than tensor parallelism or data parallelism. Therefore, the default value for the number of pipeline stages may be set to the number of NUMA nodes in the system.

If the number of layers of the model is I and the number of pipeline stages is n. the number of layers to be distributed to the i-th stage of the pipeline, kᵢ, may be calculated as shown in Equation (1).

This method may be a method of distributing an equal number of layers to each of the pipeline stages on the assumption that the performance load is the same in the layers of the model. In the case of a model having a large performance difference between the layers thereof, a method of measuring the performance load of each layer through profiling and distributing the layers in consideration of the performance load may be applied.

Also, the processor 820 performs a runtime phase in which parameters required for learning are initialized and multiple threads generated in consideration of policies of each parallelism algorithm are executed by being allocated to the multiple cores included in the NUMA node.

Here, the parameters may include global parameters for sharing data between the multiple threads and local parameters used individually by each of the multiple threads.

For example, after the model layers are distributed to the respective pipeline stages through the compile phase, global parameters for sharing output values and input values between adjacent pipeline stages may be generated. The global parameters generated or defined as described above may be used when threads for different pipeline stages share data therebetween.

Here, the local parameters may store a gradient for loss and the state of an optimizer for determining whether to apply the gradient, which are used in the backpropagation process of the learning model.

For example, Table 1 illustrates an example of code for implementing a machine-learning model written by a user.

In the example of Table 1 above, a description is made on the assumption that a machine-learning model is defined based on eight operations for convenience.

Here, when the model is used only for inference, it is necessary to define only forward operations, and when training of the model is performed, it is necessary to also define backpropagation operations. For example, in Table 1, the operations defined as ‘operation_X’ may correspond to the forward operations, and the operations defined as ‘operation_X_back’ may correspond to the backpropagation operations.

The machine-learning model defined as described above may be executed in parallel as multiple threads.

Here, because the multiple threads share the parameters when parallel execution is performed, the parameters may be defined as global parameters for sharing data between the threads. For example, the parameters defined as ‘parameter_X[ ] . . . [ ]’ in Table 1 may correspond to the global parameters.

Also, gradients for loss, an optimizer for determining how to apply the gradients when the parameters are updated, and the task for updating the parameters may be additionally required for the backpropagation process performed when the model is trained.

Accordingly, it is necessary to declare the parameters for storing the gradients (gradient_X[ ] . . . [ ]), the optimizer state (optimizer_state_X[ ] . . . [ ]), and the like, which are required for the model training process, and because the gradient and the optimizer state are used by each individual thread without being shared between the threads, they may be declared as local parameters.

These days, many deep-learning libraries provide an automatic differentiation function, and when this function is used, a backpropagation process may be automatically generated and performed merely by defining a forward process of a model. When such an automatic differentiation function is used, it is necessary to define and specify only forward operations of a model, and the gradients or optimizer state described above may not be defined because they are automatically generated.

Here, execution of the threads allocated to each of the NUMA nodes may be synchronized.

Here, the parameters may be updated for each of the NUMA nodes based on the global parameters.

Here, the parameters may be updated using any one of a method in which the multiple threads update the parameters synchronously or a method in which the multiple threads update the parameters asynchronously.

The memory 830 stores the parallelism algorithm.

Also, the memory 830 stores various kinds of information generated in the apparatus for machine-learning parallelization according to an embodiment of the present disclosure as described above.

According to an embodiment, the memory 830 may support the function for machine-learning parallelization by being configured separately from the apparatus for machine-learning parallelization. Here, the memory 830 may operate as separate mass storage, and may include a control function for performing operation.

Through the above-described apparatus for machine-learning parallelization using host CPUs of a multi-socket structure, efficient large-scale machine-learning may be enabled while minimizing performance load when parallel machine-learning based on host CPUs is performed using physical characteristics of layers of a multi-socket structure.

Also, a distributed machine-learning model using host CPUs and system memory may be effectively parallelized by utilizing physical characteristics of a NUMA node system without special computing devices, such as GPUs.

Also, a parallelization technique for minimizing load using the performance difference between interconnects of multiple layers of a system is applied, whereby performance may be improved when parallel training and inference of a large-scale model are performed.

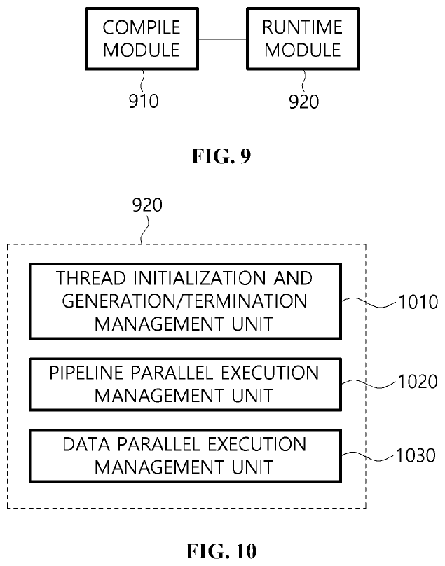

FIG. 9 is a block diagram illustrating an apparatus for machine-learning parallelization using host CPUs of a multi-socket structure according to another embodiment of the present disclosure.

Referring to FIG. 9, the apparatus for machine-learning parallelization using host CPUs of a multi-socket structure according to another embodiment of the present disclosure may include a compile module 910 and a runtime module 920.

Here, the compile module 910 may perform model splitting by reflecting the characteristics of a target system, and the runtime module 920 may be run to generate and manage multiple threads based on the result of performance by the compile module 910. Accordingly, a task for pipeline parallelism may be performed by the compile module 910, and tasks after that may be performed by the runtime module 920.

FIG. 10 is a block diagram illustrating the runtime module illustrated in FIG. 9 in detail.

Referring to FIG. 10, a runtime module 920 according to an embodiment of the present disclosure may include a thread initialization and generation/termination management unit 1010, a pipeline parallel execution management unit 1020, and a data parallel execution management unit 1030.

The thread initialization and generation/termination management unit 1010 may initialize parameters for performing deep learning and manage generation and termination of a thread.

The pipeline parallel execution management unit 1020 may perform functions to transfer output values and input values of each stage when pipeline parallelism is applied and to synchronize execution of threads according to a scheduling policy.

The data parallel execution management unit 1030 may perform a thread synchronization task related to the update of parameters in order to perform data parallel execution of a model.

Here, the update of the parameters may be performed using global parameters shared between the threads, and a method in which all of the threads synchronously update the parameters or a method in which the threads asynchronously update the parameters for performance improvement may be selectively used.

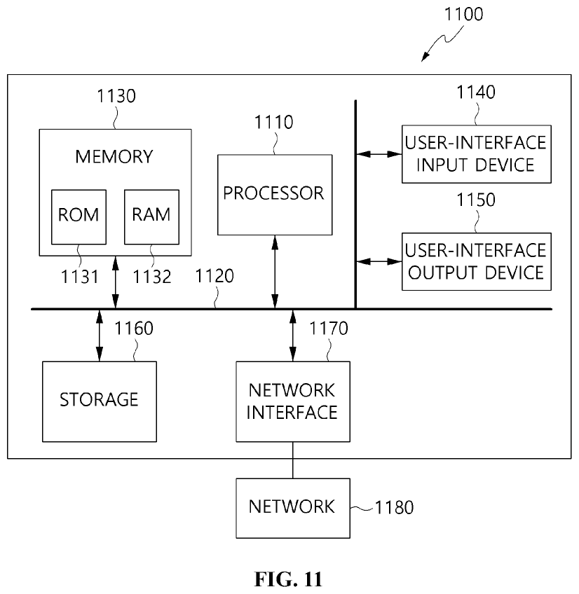

FIG. 11 is a view illustrating a computer system according to an embodiment of the present disclosure.

Referring to FIG. 11, an embodiment of the present disclosure may be implemented in a computer system including a computer-readable recording medium. As illustrated in FIG. 11, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

Accordingly, an embodiment of the present disclosure may be implemented as a non-transitory computer-readable medium in which methods implemented using a computer or instructions executable in a computer are recorded. When the computer-readable instructions are executed by a processor, the computer-readable instructions may perform a method according to at least one aspect of the present disclosure.

According to the present disclosure, when parallel machine-learning based on host CPUs is performed using physical characteristics of each layer of a multi-socket system, efficient large-scale machine-learning may be enabled while minimizing performance load.

Also, the present disclosure may effectively parallelize a distributed machine-learning model using host CPUs and system memory by utilizing physical characteristics of a NUMA node system without special computing devices, such as GPUs.

Also, the present disclosure applies a parallelization technique for minimizing load using a performance difference between interconnects of multiple layers of a system, thereby improving performance in parallel training and inference of a large-scale model.

As described above, the method for machine-learning parallelization using host CPUs of a multi-socket structure and the apparatus therefor according to the present disclosure are not limitedly applied to the configurations and operations of the above-described embodiments, but all or some of the embodiments may be selectively combined and configured, so the embodiments may be modified in various ways.

What is claimed is:

1. A method for machine-learning parallelization using host CPUs of a multi-socket structure, performed by an apparatus for machine-learning parallelization using host CPUs of a multi-socket structure, comprising:
performing a compile phase in which a learning model is split at a layer level for respective pipeline stages and allocated to Non-Uniform Memory Access (NUMA) nodes for respective CPU sockets; and
performing a runtime phase in which parameters required for learning are initialized and multiple threads generated in consideration of a policy of each parallelism algorithm are executed by being allocated to multiple cores included in the NUMA node.

2. The method of claim 1, wherein:
the NUMA node for each of the CPU sockets includes a CPU, including multiple cores, and memory,
the multiple cores share the memory via an interconnect between the cores, and the NUMA node for each of the CPU sockets shares memory of each NUMA node via an interconnect between the sockets.

3. The method of claim 1, wherein:
a default value for a number of pipeline stages is set to correspond to a number of NUMA nodes, and
an equal number of model operations is distributed to each of the NUMA nodes.

4. The method of claim 1, wherein the parameters include global parameters for sharing data between the multiple threads and local parameters used individually by each of the multiple threads.

5. The method of claim 4, wherein the local parameters store a gradient for loss and a state of an optimizer for determining whether to apply the gradient, which are used in a backpropagation process of the learning model.

6. The method of claim 4, wherein the runtime phase includes
synchronizing execution of the threads allocated to each of the NUMA nodes; and
updating the parameters for each of the NUMA nodes based on the global parameters.

7. The method of claim 6, wherein updating the parameters comprises updating the parameters using any one of a method in which the multiple threads synchronously update the parameters and a method in which the multiple threads asynchronously update the parameters.

8. An apparatus for machine-learning parallelization using host CPUs of a multi-socket structure, comprising:
a processor for splitting a learning model at a layer level for respective pipeline stages, allocating parts of the split learning model to Non-Uniform Memory Access (NUMA) nodes for respective CPU sockets, initializing parameters required for learning, and executing multiple threads generated in consideration of a policy of each parallelism algorithm by allocating the multiple threads to multiple cores included in the NUMA node; and
memory for storing the parallelism algorithm.

9. The apparatus of claim 8, wherein:
the NUMA node for each of the CPU sockets includes a CPU, including multiple cores, and memory,
the multiple cores share the memory via an interconnect between the cores, and
the NUMA node for each of the CPU sockets shares memory of each NUMA node via an interconnect between the sockets.

10. The apparatus of claim 8, wherein:
a default value for a number of pipeline stages is set to correspond to a number of NUMA nodes, and
an equal number of model operations is distributed to each of the NUMA nodes.

11. The apparatus of claim 8, wherein the parameters include global parameters for sharing data between the multiple threads and local parameters used individually by each of the multiple threads.

12. The apparatus of claim 11, wherein the local parameters store a gradient for loss and a state of an optimizer for determining whether to apply the gradient, which are used in a backpropagation process of the learning model.

13. The apparatus of claim 11, wherein the processor synchronizes execution of the threads allocated to each of the NUMA nodes and updates the parameters for each of the NUMA nodes based on the global parameters.

14. The apparatus of claim 13, wherein the processor performs parameter update using any one of a method in which the multiple threads synchronously update the parameters and a method in which the multiple threads asynchronously update the parameters.
